(19) United States
(12) Patent Application Publication
(10) Pub. No.: US 2009/0123130 A1
(43) Pub. Date: May 14, 2009

(54) METHOD OF RECORDING CONTENT DATA, AND METHOD OF PROCESSING DATA AND TRANSCODING DEVICE THEREFOR

(75) Inventor: Ji-sang KIM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/877,761

(22) Filed: Oct. 24, 2007

(30) Foreign Application Priority Data
Mar. 26, 2007 (KR) 2007-29366

(51) Int. Cl. H04N 7/26; H04L 9/32

(52) U.S. Cl. 386/124; 726/6; 386/E05.001

(57) ABSTRACT

A method of recording content data of system including a transcoding device connectable to a recorder, via a communication network. The method includes transcoding source content data into transcoded content data, transmitting, without recording the transcoded content data locally, the transcoded content data to the recorder via the communication network in substantially real time, and recording the transcoded content data onto a recording medium. Accordingly, the content data can be directly recorded onto a recording medium of another device, not on a recoding medium related to the transcoding device. Consequently, an apparatus including the transcoding device can obtain content data without a limit on storage capacity.

### CROSS-REFERENCE TO RELATED APPLICATION

This application claims all benefits accruing under 35 U.S.C. §119 from Korean Patent Application No. 2007-29366, filed in the Korean Intellectual Property Office on Mar. 26, 2007, the disclosure of which is incorporated herein by reference.

### BACKGROUND OF THE INVENTION

1. Field of the Invention

Aspects of the present invention relate to a method of recording content data, and a method of processing data and a transcoding device therefor, and more particularly, to a method of recording content data via a recorder after transcoding the content data, and a method of processing data and a transcoding device therefor.

2. Related Art

A conventional content recorder records various types of content, such as video, audio, and streaming media, on a recording medium. The streaming media may be from a TV broadcast, a camcorder, or a mobile phone including an imaging sensor. Source content recorded on the recording medium can be transmitted to other devices when required. The source content recorded on the recording medium can also be realized by other devices, unlike the content recorder.

If a target device, using the source content, uses a data format different from a data format used by the recorder, then the target device cannot reproduce the source content. Accordingly, a conventional content recorder transcodes the source content to a target data format, for example, a web format, which can be used by various target devices, before recording the source content. The transcoding process directly converts one data format to another data format. Transcoding is used in various content adaptation fields, including a mobile phone content adaptation field.

A conventional content recorder records content onto a self-owned recording medium, such as a hard drive or removable storage medium, and then transmits the recorded content to target devices when required. Accordingly, in order to transmit the data to the target devices, a separate operation, such as manipulation by a user, is required. In addition, source content cannot be stored if the storage space of the self-owned recording medium is not sufficient.

### SUMMARY OF THE INVENTION

Aspects of the present invention provide a transcoding device that can transmit transcoded content data to a recorder without recording the content data onto a self-owned recording medium.

Aspects of the present invention also provide a method of processing data of a transcoding device that enables the transcoding device to transmit transcoded content data to a recorder without recording the content data in a self-owned recording medium.

Aspects of the present invention also provide a method of recording content data of a system including a transcoding device and a recorder connected via a communication network.

Additional aspects and/or advantages of the invention will be set forth in part in the description which follows and, in part, will be obvious from the description, or may be learned by practice of the invention.

According to an aspect of the present invention, a transcoding device connectable to a recorder for recording transcoded content data, via a communication network, is provided. The transcoding device includes a transcoder to transcode source content data into transcoded and to output content data in a predetermined format suitable for use by the recorder; and a communicator to transmit, without recording the transcoded content data locally, the transcoded content data outputted from the transcoder to the recorder, via the communication network, for recording onto a recording medium.

According to another aspect of the present invention, the transcoding device transmits the transcoded content data to the recorder in substantially real time.

According to another aspect of the present invention, a method of processing data of a transcoding device connectable to a recorder for recording transcoded content data, via a communication network, is provided. The method includes transcoding content data in a predetermined format; and transmitting, without recording the transcoded content data locally, the transcoded content data to the recorder, via the communication network, in substantially real time so as to allow the recorder to record the content data onto a recordable medium.

According to another aspect of the present invention, a method of recording content data of a system including a transcoding device connected to a recorder via a communication network is provided. The method includes transcoding source content data into transcoded content data suitable for use with the recorder; transmitting, without recording the transcoded content data locally, the transcoded content data to the recorder, via the communication network, in substantially real time; and recording the transcoded content data onto a recording medium.

According to another aspect of the present invention, a request signal, which requests the recorder to record the transcoded content data, is transmitted together with the transcoded content data.

According to another aspect of the present invention, the predetermined format may be a web format.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a conceptual diagram of a system for recording web according to an example embodiment of the present invention;

FIG. 2 is a detailed diagram of the transcoding device shown in FIG. 1;

FIG. 3 is a diagram of a system for recording web, in which a transcoding device illustrated in FIG. 1 is realized in a mobile device; and

FIG. 4 is a diagram of a system for recording web, in which a transcoding device illustrated in FIG. 1 is realized in a TV set.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

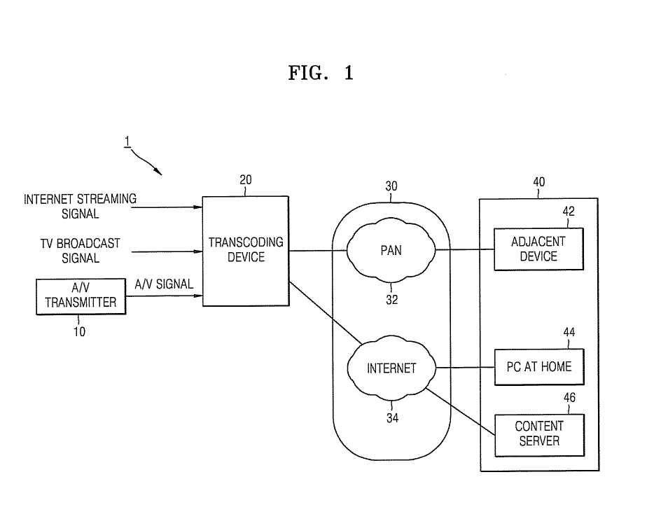

FIG. 1 is a conceptual diagram of a system 1 for recording content (such as content received from the World Wide Web) according to an example embodiment of the present invention. The system 1 includes an A/V transmitter 10, a transcoding device 20, a communication network 30, and a recorder 40.

The A/V transmitter 10 transmits an audio/video signal, which contains user-created content (UCC), movies, music, or the like, to the transcoding device 20. The A/V transmitter 10 may be a device including an imaging sensor, such as a camcorder or a digital camera, or may be a mobile phone or other mobile device. The transcoding device 20 may receive the audio/video signal from the A/V transmitter 10. The transcoding device 20 may also receive an Internet streaming signal or a TV broadcast signal, or may generate the content directly (for example, by taking a picture.) The Internet streaming signal may be A/V data in Windows Media Video (WMV) format. The transcoding device 20 generates transcoded content data from the received signal. The transcoded content data is transmitted to the recorder 40, via the communication network 30. The transcoding device 20 may transmit the transcoded content data together with a request signal, which requests the recorder 40 to record the transcoded content data onto a self-owned recording medium (not shown). The communication network 30 includes a personal area network (PAN) 32 and an Internet 34, as well as other types of networks.

The recorder 40 records the transcoded content data transmitted from the transcoding device 20 in the self-owned recording medium in response to the request signal. The recorder 40 may be an adjacent device 42, a host computer (such as a PC at home) 44, and/or a content server 46. The adjacent device 42 is connected to the transcoding device 20 via a communication network, such as the PAN 32. The PAN 32 is used for a mutual communication between information technology (IT) devices located in a personal domain within a radius of about 10 meters from each other. The PAN 32 may be a wired network connected by a computer bus, such as a Universal Serial Bus (USB) or FireWire, or may be a wireless network technology, such as an infrared data association (IrDA) or Bluetooth. The content server 46 and the PC at home 44 are connected to the transcoding device 20, via the Internet 34.

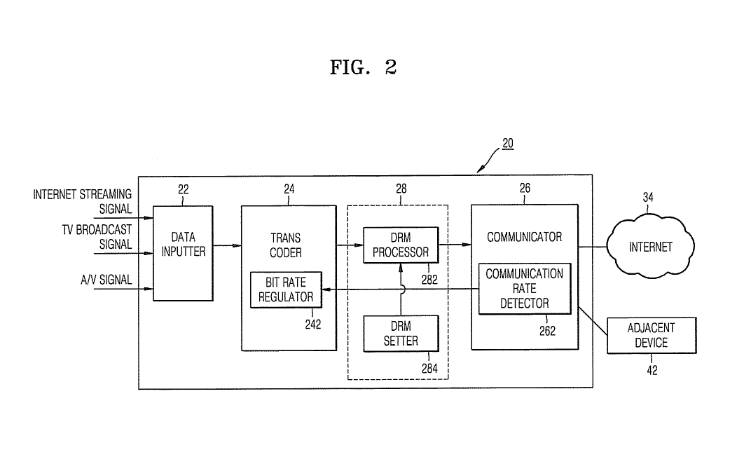

FIG. 2 is a detailed diagram of the transcoding device 20 shown in FIG. 1. The transcoding device 20 includes a data inputter 22, a transcoder 24, a communicator 26, and a digital rights management (DRM) manager 28. According to other aspects of the invention, the transcoding device 20 may include additional and/or different units. Similarly, the functionality of two or more of the above units may be integrated into a single component.

The data inputter 22 receives an internet streaming signal, a TV broadcast signal, and/or an audio/video signal. The internet streaming signal may be received via a wired internet modem or a wireless internet modem. The TV broadcast signal may be received via a tuner or a set-top box. The audio/video signal from the A/V transmitter 10 of FIG. 1 may be received via a communication device, such as Bluetooth or USB. The data inputter 22 converts the received signal into data that can be processed by the transcoder 24. Accordingly, content data outputted from the data inputter 22 may be streamed content data, broadcast content data, or raw audio/video data. The content data is provided to the transcoder 24.

The transcoder 24 transcodes and outputs the received content data in a predetermined format. The predetermined format may be a web format, that is, a format suitable for viewing via the World Wide Web. The communicator 26 transmits the transcoded content data outputted from the transcoder 24 to the recorder 40, such as the adjacent device 42, the content server 46, or the PC at home 44, via the communication network 30, such as the PAN 32 or the internet 34.

In an example embodiment, the transcoding device 20 performs a function for adaptively regulating a transfer rate of a transmission signal so that the transfer rate of the transmission signal is adjusted to a communication bandwidth of a communication path formed between the transcoding device 20, the communication network 30, and the recorder 40. In order to perform this function, the transcoder 24 includes a bit rate regulator 242, and the communicator 26 includes a communication rate detector 262. The communication rate detector 262 detects a transfer rate of the communicator 26 transmitting the transcoded content data, and provides the detected transfer rate to the bit rate regulator 242. The bit rate regulator 242 regulates a target rate for transcoding the content data, which is a bit rate, based on the transfer rate received from the communication rate detector 262. For example, as the bandwidth of the communication path decreases, the bit rate decreases, and as the bandwidth of the communication path increases, the bit rate increases. The bit rate is a rate of the transcoder 24 transcoding content data, and the bit rate and the transfer rate have a different meaning. The transcoder 24 transcodes the content data in the bit rate regulated by the bit rate regulator 242. As a result, the transcoding device 20 can transmit the transcoded content data to the recorder in the transfer rate suitable to the bandwidth of the communication path between the transcoding device 20 and the recorder 40.

The bit rate of the transcoding device 20 transcoding the content data may sometimes be too low. Accordingly, the transcoding device 20 may include a buffer (not shown) in order to prevent losing content data obtained by the data inputter 22. The buffer may be used to store content data that has not yet been transcoded. The buffer may alternatively be installed inside the data inputter 22 or the transcoder 24.

In an example embodiment, the DRM manager 28 is located between the transcoder 24 and the communicator 26. The DRM manager 28 receives the transcoded content data from the transcoder 24, DRM processes the received content data, and outputs the DRM processed content data to the communicator 26. The DRM manager 28 includes a DRM processor 282 and a DRM setter 284.

The DRM processor 282 processes the transcoded content data using DRM technologies. Any DRM technology may be used by the DRM processor 282. For example, a packager technology, which encrypts the transcoded content data so that only permitted users can use the content data and packages the encrypted content data in a sure container file format, may be used for the DRM process. For encoding the content data, a data encryption standard (DES), an advanced encryption standard (AES), or other encryption techniques may be used.

The DRM setter 284 sets usage conditions and rights that a user needs to satisfy in order to use content protected by a DRM technology. In the DRM setter 284, usage conditions and rights of the transcoded content data may be set according to a user input via a user interface provided by the transcoding device 20. Alternatively, the DRM setter 284 sets usage conditions and rights, using a self-owned default value. The DRM setter 284 may allow a user to input data showing a rights owner of the transcoded content data. Accordingly, a user of the transcoding device 20 can indicate that he/she owns the rights of UCC prepared by an imaging device, such as a camcoder. Consequently, the DRM method can be realized in the current embodiment, by using the DRM manager 28.

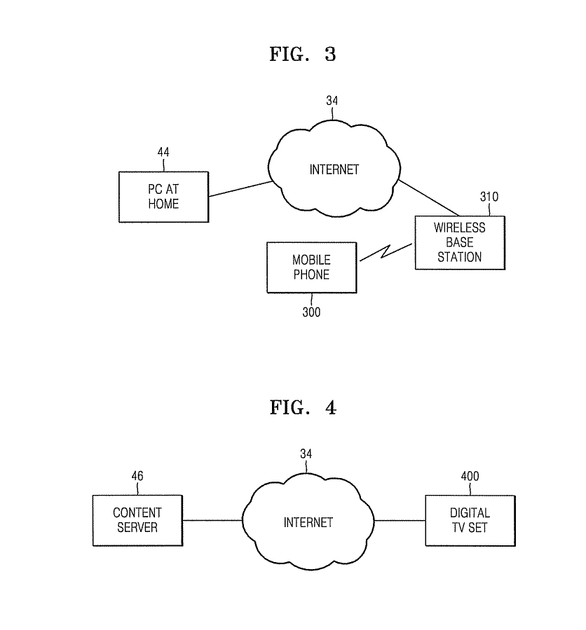

FIG. 3 is a diagram of the system 1 shown in FIG. 1, in which the transcoding device 20 is realized in a mobile device, such as a mobile phone 300, a personal digital assistant (PDA) (not shown), or a personal entertainment device (not shown). The mobile phone 300 may include the A/V transmitter 10 of FIG. 1 and the transcoding device 20 of FIG. 2. As shown in FIG. 3, the system 1 may include the mobile phone 300, a PC at home 44, and a wireless base station 310. Additional devices may also be present but are not shown for purposes of clarity.

Processes of recording transcoded content data outputted from the mobile phone 300 on a recording medium of a PC at home 44 will now be described with reference to FIG. 3. In order to record an A/V signal via the PC at home 44, the mobile phone 300 is connected to the PC at home 44 via a wireless base station 310 and an internet (or other network) 34 using a communication unit, such as a CDMA modem (not shown). The mobile phone 300 generates the A/V signal containing A/V content obtained by a built in camera (not shown) and/or a microphone (not shown). The transcoding device 20 inside the mobile phone 300 generates transcoded content data by processing the A/V signal, and also generates a request signal, which requests the PC at home 44 (acting as the recorder 40) to record the transcoded content data. The transcoded content data and the request signal are transmitted from the mobile phone 300 to the PC at home 44 via the wireless base station 310 and the Internet 34. In response to the request signal, the PC at home 44 records the transcoded content data, received with the request signal, on its own recording medium, such as a hard disc drive, flash memory drive, or a USB memory drive.

FIG. 4 is another diagram of the system 1 shown in FIG. 1, in which the transcoding device 20 is realized in a TV set, such as a digital TV set 400. The digital TV set 400 may include the transcoding device 20 of FIG. 2. The digital TV set 400 may also include a tuner or an inputter for receiving a digital TV broadcast signal, such as a satellite set-top box, either integrated with the digital TV set 400 or in a separate, stand-alone component. The digital TV set 400 may be connected to the Internet 34 via a LAN modem (not shown).

Processes of recording transcoded content data outputted from the digital TV set 400 on a content server 46 will now be described with reference to FIG. 4. The digital TV set 400 is connected to the content server 46, via the Internet (or other network) 34. The content server 46 may be located anywhere, such as in the user's home or at a remote location. The digital TV set 400 obtains content data from the received digital TV broadcast signal. The obtained content data is converted to transcoded content data by the transcoding device 20 inside the digital TV set 400. The transcoding device 20 also generates a request signal, which requests the content server 46 (here, acting as the recorder 40) to record the transcoded content data. The transcoded content data and the request signal are transmitted from the digital TV set 400 to the content server 46 via the internet 34. The content server 46 records the transcoded content data, received with the request signal, on a recording medium of the content server 46, such as a hard disc drive or a removable storage medium, in response to the request signal.

The recorder 40, in which the transcoded content generated by the transcoding device 20, is pre-selected in the example embodiments described above. However, the present invention should not be construed as being limited to the example embodiments set forth herein. The transcoding device 20 may select the recorder 40 based on a user input via a user interface. Information used to select the recorder 40 may contain an address that enables a communication network to recognize a certain recorder, such as a recorder's unique ID, an internet address, or the like. A user interface for selecting the recorder 40 may be the DRM setter 284. Alternatively, a user interface provided by the mobile phone 300 or the digital TV set 400 may be used to select the recorder 40.

The transcoding device 20 and the PAN 32 or the internet 34 may communicate using a well-known communication protocol related to the PAN 32 or the Internet 34. Such communication protocol is well known to one of ordinary skill in the art, and thus details thereof will be omitted herein.

As described above, according to aspects of the present invention, content data can be directly recorded on a recording medium of another device, not on a recording medium related to a transcoding device. Accordingly, an apparatus including the transcoding device can obtain content data without a limitation to the storage capacity of the apparatus. When the apparatus including the transcoding device is used as an apparatus for UCC, such unlimited storage capacity is very advantageous.

According to other aspects of the present invention, transcoded content data is processed using a DRM technology. Accordingly, the transcoded content data can be used only by a user by storing the transcoded content data in a PC at home or can be shared with others by storing the transcoded content data in a content server. Also, the content data can be shared or independently used while being stored in the content server via a DRM process.

Aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, even though the transcoder outputs the content data without permanently storing the content data (i.e., in a storage medium of the transcoder), the transcoder may still temporarily store the content data during the transcoding process, such as in the buffer described above. Additionally, the DRM manager may apply the DRM process based on the user's settings or on settings contained within the content, or may not apply the DRM process at all. Accordingly, it is intended, therefore, that the present invention not be limited to the various example embodiments disclosed, but that the present invention includes all embodiments falling within the scope of the appended claims.

What is claimed is:

1. A transcoding device connectable to a recorder for recording transcoded content data, via a communication network, the transcoding device comprising:
a transcoder to transcode source content data into transcoded content data and to output the transcoded content data in a predetermined format suitable for use by the recorder; and
a communicator to transmit, without recording the transcoded content locally, the transcoded content data to the recorder, via the communication network, for recording onto a recording medium.

2. The transcoding device of claim 1, wherein the communicator transmits a request signal, which requests the recorder to record the transcoded content data, together with the transcoded content data.

3. The transcoding device of claim 1, wherein the predetermined format is a web format.

4. The transcoding device of claim 1, wherein the communicator transmits the transcoded content data to the recorder in substantially real time.

5. The transcoding device of claim 4, wherein the communicator comprises a transfer rate detector to detect a transfer rate of transmitting the content data from the transcoding device to the recorder via the communication network.

6. The transcoding device of claim 5, wherein the transcoder comprises a bit rate regulator to receive the transfer rate from the transfer rate detector and to regulate a bit rate for transcoding the content data based on the received transfer rate.

7. The transcoding device of claim 1, further comprising a digital rights manager located between the transcoder and the communicator to apply a digital rights management (DRM) process to the transcoded content data.

8. The transcoding device of claim 1, further comprising:
a content data inputter to provide content data to the transcoder that can be processed by the transcoder;
wherein the content data inputter converts raw content data to the content data that can be processed by the transcoder.

9. The transcoding device of claim 8, wherein the raw content data is at least one of streamed content data, broadcast content data, and raw audio/video data.

10. A method of processing data of a transcoding device connectable to a recorder for recording transcoded content data, via a communication network, the method comprising:
transcoding content data in a predetermined format; and
transmitting, without recording the transcoded content data locally, the transcoded content data to the recorder, via the communication network, in substantially real time so as to allow the recorder to record the content data onto a recordable medium.

11. The method of claim 10, wherein a request signal, which requests the recorder to record the transcoded content data, is transmitted together with the transcoded content data.

12. The method of claim 10, wherein the predetermined format is a web format.

13. The method of claim 10, wherein the transmitting of the transcoded content data comprises:
detecting a transfer rate of transmitting content data from the transcoding device to the recorder via the communication network; and
regulating a bit rate of transcoding the content data based on the detected transfer rate.

14. The method of claim 10, further comprising applying a DRM method to the transcoded content data prior to transmitting the transcoded content data.

15. The method of claim 10, further comprising:
converting raw content data to the content data;
wherein the raw content data is at least one of streamed content data, broadcast content data, and raw audio/video data.

16. A method of recording content data of a system including a transcoding device connected to a recorder via a communication network, the method comprising:
transcoding source content data into transcoded content data suitable for use with the recorder;
transmitting, without recording the transcoded content data locally, the transcoded content data to the recorder via the communication network in substantially real time; and
recording the transcoded content data onto a recording medium.

17. The method of claim 16, wherein a request signal, which requests the recorder to record the transcoded content data, is transmitted to the recorder together with the transcoded content data.

18. The method of claim 16, wherein the transmitting of the transcoded content data comprises:
detecting a transfer rate of transmitting content data from the transcoding device to the recorder via the communication network; and
regulating a bit rate of transcoding the content data based on the detected transfer rate.

19. The method of claim 16, further comprising applying a DRM method on the transcoded content data prior to transmitting the transcoded content data.

20. The transcoder of claim 7, wherein the DRM manager comprises:
a DRM setter to set usage conditions and rights on the content data; and
a DRM processor to apply the DRM process to the content data based on the usage conditions and rights set by the DRM setter.

21. The transcoder of claim 1, wherein the recorder to which the transmitter communicates the content data is determined based on user input.

22. The transcoder of claim 1, wherein the transcoding device is a mobile device.

23. The transcoder of claim 1, further comprising a buffer to temporarily store the content data while the content data is transcoded.

24. A computer readable medium having instructions encoded thereon to perform a method of transcoding received content data, the method comprising:
transcoding content data received from a content generator into a predetermined format readable by a recorder; and
outputting, without recording the transcoded content data locally, the transcoded content data to the recorder for recording onto a recordable medium.

25. The computer readable medium of claim 24, further comprising transmitting to the recorder a request to record the transcoded content data onto the recordable medium.
